(19) United States
(12) Patent Application Publication
(10) Pub. No.: US 2006/0044142 A1
(43) Pub. Date: Mar. 2, 2006

(54) Method and system for generating an emergency signal

(76) Inventors: Jose E. Korneluk, Boynton Beach, FL (US); Von A. Mock, Boynton Beach, FL (US)

Correspondence Address: Larry G. Brown;Motorala, Inc., Law Department, 8000 West Sunrise Boulevard, Fort Lauderdale, FL, 33322, US

(21) Appl. No.: 10/930,070

(22) Filed: Aug. 31, 2004

(51) Int. Cl. G08B 23/00; G08B 1/00; G08B 1/08

(52) U.S. Cl. 340/573.4; 340/539.12; 340/531

(57) ABSTRACT

The invention concerns a method (300, 500) and system (100) for generating an emergency signal. The method can include the steps of detecting (312) at a mobile unit (110) the existence of at least one marker associated with a potential emergency, determining (314) whether the marker has reached a predetermined threshold and if the marker has reached the predetermined threshold, initiating (318) an emergency signal to potentially provide searching personnel with a location of a user of the mobile unit. As an example, the marker can be at least one of a movement of the mobile unit and a crash sound. In addition, the emergency signal can be a vibrational signal, an acoustic signal or a radio frequency signal.

### BACKGROUND OF THE INVENTION

1. Field of the Invention

This invention relates in general to methods and systems that generate emergency signals and more particularly, methods and systems that do so in response to a situation where a user may be trapped or otherwise incapacitated.

2. Description of the Related Art

In recent years, portable electronic devices, such as cellular telephones and personal digital assistants, have become commonplace. One particular reason why people carry such devices is to be able to communicate in an emergency situation. As an example, a person who witnesses an accident or a crime and who carries a mobile unit may call emergency personnel to the scene. A mobile unit can be very effective in assisting persons in these situations.

In view of recent tragedies, however, a mobile unit's effectiveness may become lessened when individuals are trapped in a collapsed building. For example, if a victim is unconscious or pinned beneath a significant amount of rubble, the victim may not be able to operate his or her mobile unit. Even if the trapped person is able to operate his or her mobile unit, the network to which the mobile unit is assigned may be damaged or otherwise inoperable. This lack of effectiveness may hinder emergency crews in their search for survivors.

### SUMMARY OF THE INVENTION

The present invention concerns a method for generating an emergency signal. The method can include the steps of detecting at a mobile unit the existence of at least one marker associated with a potential emergency, determining whether the marker has reached a predetermined threshold and if the marker has reached the predetermined threshold, initiating an emergency signal to potentially provide searching personnel with a location of a user of the mobile unit. As an example, the marker can be a movement of the mobile unit or a crash sound.

In one arrangement, the emergency signal can be a vibrational signal. The method can further include the steps of generating the vibrational signal with a vibrational component of the mobile unit and receiving the vibrational signal at at least one receiving unit. In another arrangement, the method can further include the step of encoding the vibrational signal with a predetermined sequence to at least enable the receiver to detect the vibrational signal in the presence of other vibrational, non-emergency signals.

In addition, the vibrational signal can have a predetermined frequency, and the method can include the step of positioning the receiving units substantially at a predetermined distance from one another. The predetermined distance can be either an integer or a fractional wavelength of the predetermined frequency of the vibrational signal. The method can also include the step of comparing detection times of the receiving units in which a detection time can be when the receiving unit receives the vibrational signal.

In another embodiment of the invention, the emergency signal can be an acoustic signal. The method can further include the steps of broadcasting the acoustic signal with a transducer of the mobile unit and receiving the acoustic signal at at least one receiving unit. The method can also include the step of encoding the acoustic signal with a predetermined sequence. The acoustic signal can have a predetermined frequency, and the method can further include the step of positioning the receiving units substantially at a predetermined distance from one another. The predetermined distance can be an integer or a fractional wavelength of the predetermined frequency of the acoustic signal. The method can also include the step of comparing detection times of the receiving units in which a detection time can be when the receiving unit receives the acoustic signal.

In yet another embodiment of the invention, the emergency signal can be a radio frequency signal. Here, the method can include the steps of generating the radio frequency signal with a transmitter of the mobile unit and receiving the radio frequency signal at at least one receiving unit. The method can also include the step of encoding the radio frequency signal with a predetermined emergency message.

The radio frequency signal can have a predetermined frequency, and the method can include the step of positioning the receiving units substantially at a predetermined distance from one another. The predetermined distance can be at least one of an integer and a fractional wavelength of the predetermined frequency of the radio frequency signal. The method can also include the step of comparing detection times of the receiving units in which a detection time can be when the receiving unit receives the radio frequency signal. In another arrangement, the method can also include the step of—when the marker has reached the predetermined threshold—waiting a predetermined amount of time before initiating the emergency signal to permit the user to prevent the emergency signal from being initiated.

The present invention also concerns another method for generating an emergency signal. The method can include the steps of receiving an activation signal from an input from a user of a mobile unit, in response to the receipt of the activation signal, generating at least one of a vibrational signal and an acoustic signal and receiving at least one of the vibrational signal and the acoustic signal at at least one receiving unit. The vibrational signal or the acoustic signal potentially provide searching personnel with a location of the user of the mobile unit. The generating step can further include generating at least one of the vibrational signal, the acoustic signal and a radio frequency signal. The receiving step can further include receiving the radio frequency signal at the receiving unit. The radio frequency signal can potentially provide searching personnel with a location of the user of the mobile unit.

The present invention also concerns a system for generating an emergency signal. The system can include a mobile unit that can have a detection component in which the detection component detects at the mobile unit the existence of at least one marker associated with a potential emergency. The system can also include a processor coupled to the detection component, in which the processor is programmed to determine whether the marker has reached a predetermined threshold, and a signal generation component coupled to the processor. The processor is programmed to signal the signal generation component when the detected marker has reached the predetermined threshold. In response, the signal generation component generates an emergency signal to potentially provide searching personnel with a location of a user of the mobile unit. The system can also include suitable software and/or circuitry to carry out the processes described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a system for generating an emergency signal in accordance with an embodiment of the inventive arrangements;

FIG. 2 illustrates several components of the system of FIG. 1 in block diagram form in accordance with an embodiment of the inventive arrangements;

FIG. 3 illustrates a portion of a method for generating an emergency signal in accordance with an embodiment of the inventive arrangements;

FIG. 4 illustrates another portion of the method for generating an emergency signal of FIG. 3 in accordance with an embodiment of the inventive arrangements; and

FIG. 5 illustrates another method for generating an emergency signal in accordance with an embodiment of the inventive arrangements.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

This invention presents a method and system for generating an emergency signal. In one arrangement, the existence of at least one marker associated with a potential emergency can be detected at a mobile unit, and it can be determined whether the marker has reached a predetermined threshold. If the marker has reached the predetermined threshold, an emergency signal can be initiated to potentially provide searching personnel with a location of a user of the mobile unit. As an example, the marker can be a movement of the mobile unit or a crash sound. As another example, the emergency signal can be a vibrational signal generated by a vibrational component of the mobile unit, an acoustic signal generated by an acoustic transducer of the mobile unit or a radio frequency (RF) signal generated by a transmitter of the mobile unit.

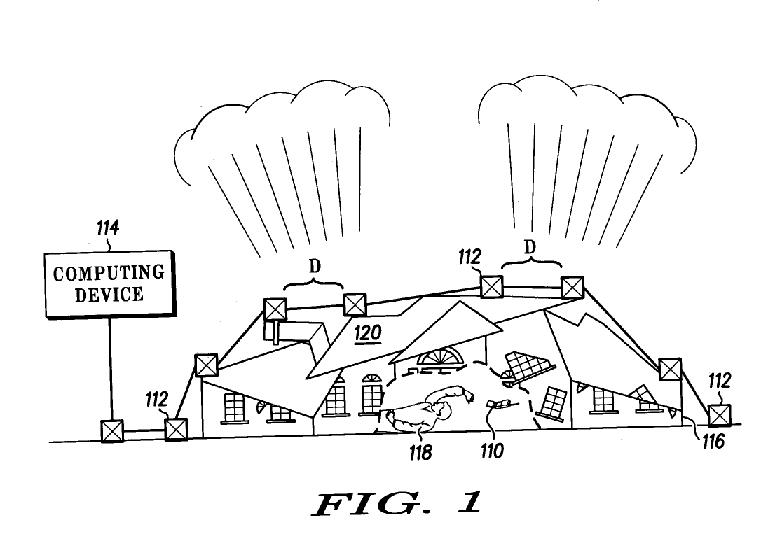

Referring to FIG. 1, a system 100 for generating an emergency signal is shown. In one arrangement, the system 100 can include a mobile unit 110, one or more receivers 112 and a computing device 114. The mobile unit 110 can be, for example, a mobile communication unit such as a cellular telephone, a personal digital assistant (PDA), a two-way radio, etc. It is understood, however, that the term mobile unit 110 can include any device that is capable of generating an emergency signal that may potentially provide searching personnel with a location of a user of the mobile unit 110. As an example, the emergency signal can be at least one of an acoustic signal, a vibrational signal or an RF signal.

For purposes of the invention, a vibrational signal can be any signal that is generated by a vibrating device, such as a vibrator on a cellular telephone or PDA. An acoustic signal can be any signal that is generated by any number of components (like an audio transducer) that are capable or generating sound, including signals that may or may not be audible to a human. Additionally, an RF signal can be any electromagnetic wave that is propagated through a suitable medium. Of course, it is understood that the invention is not so limited, as the emergency signal can be any other suitable signal that can be used to help locate a user of the mobile unit 110.

In the illustration shown in FIG. 1, a building 116 has collapsed, and a person 118 is trapped beneath a pile of rubble or debris 120. This person 118 can be a user of the mobile unit 110 and can be conscious, semi-conscious or unconscious. In such a scene, searching personnel may begin to search for survivors of the collapse. In one arrangement, the receivers 112 can be strategically positioned around the pile of debris 120 for purposes of receiving the emergency signal being generated by the mobile unit 110. In another arrangement, the receivers 112 can be positioned a predetermined distance D from one another. As will be explained later, this positioning scheme can help the receivers 112 better receive the generated emergency signal.

When the receivers 112 receive the emergency signal, the receivers 112 can signal the computing device 114 of this occurrence. Based on the receipt of the emergency signal by the receivers 112, the computing device 114 can determine at least an approximate location of the mobile unit 110. If the location of the mobile unit 110 is known, there is a strong possibility that searching personnel may find a user of the mobile unit 110 (e.g., the person 118).

The emergency signal, whether it is a vibrational, acoustic or RF signal, can be encoded with information that can also be received at the receiver 112 and transferred to the computing device 114. As an example, the emergency signal can be encoded with information, such as a predetermined sequence or emergency message. Although the receivers 112 as pictured in FIG. 1 are shown coupled together with hard-wired connections, it is understood that the receivers 112 can transfer data to the computing device 114 over a wireless communications link, such as a Bluetooth or Wireless Fidelity (Wi-Fi) connection.

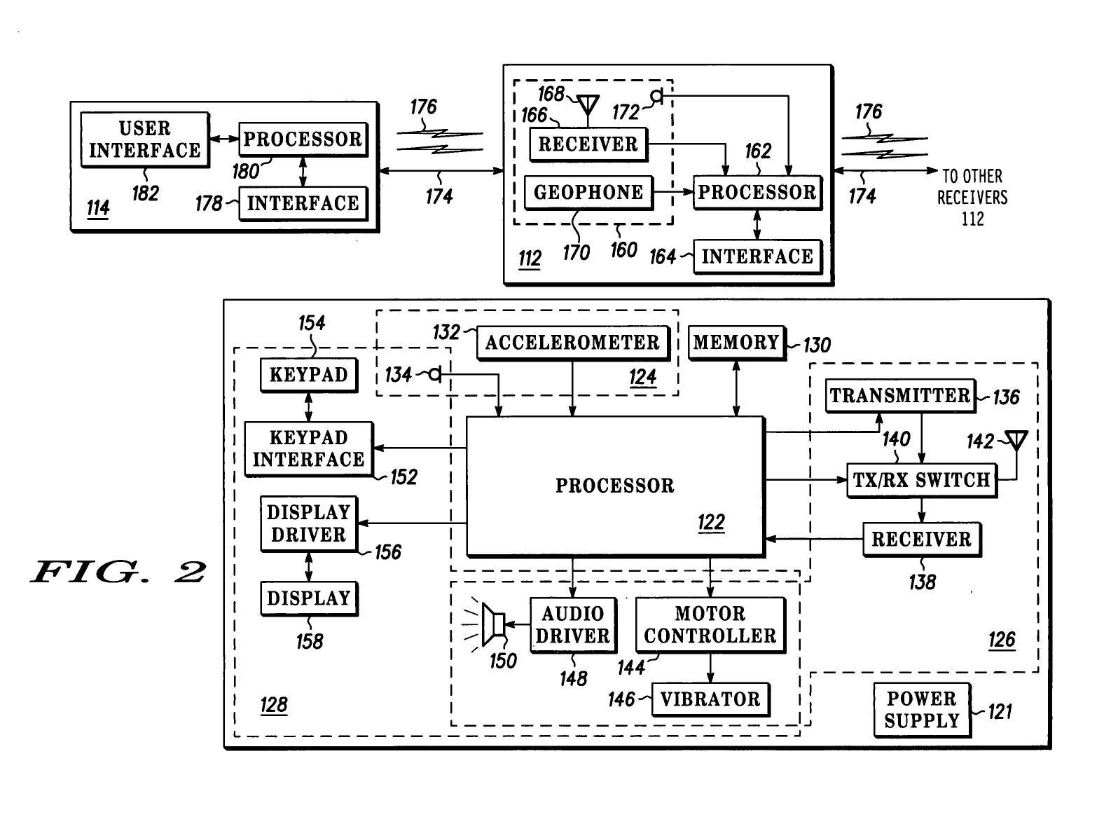

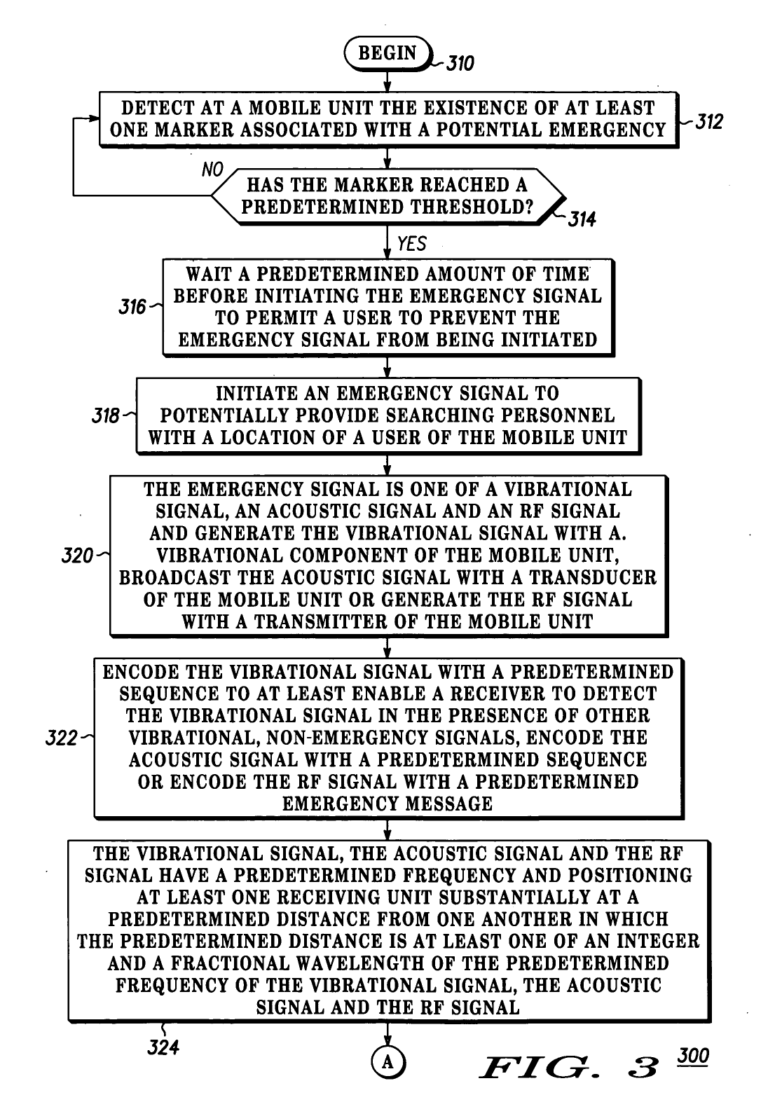

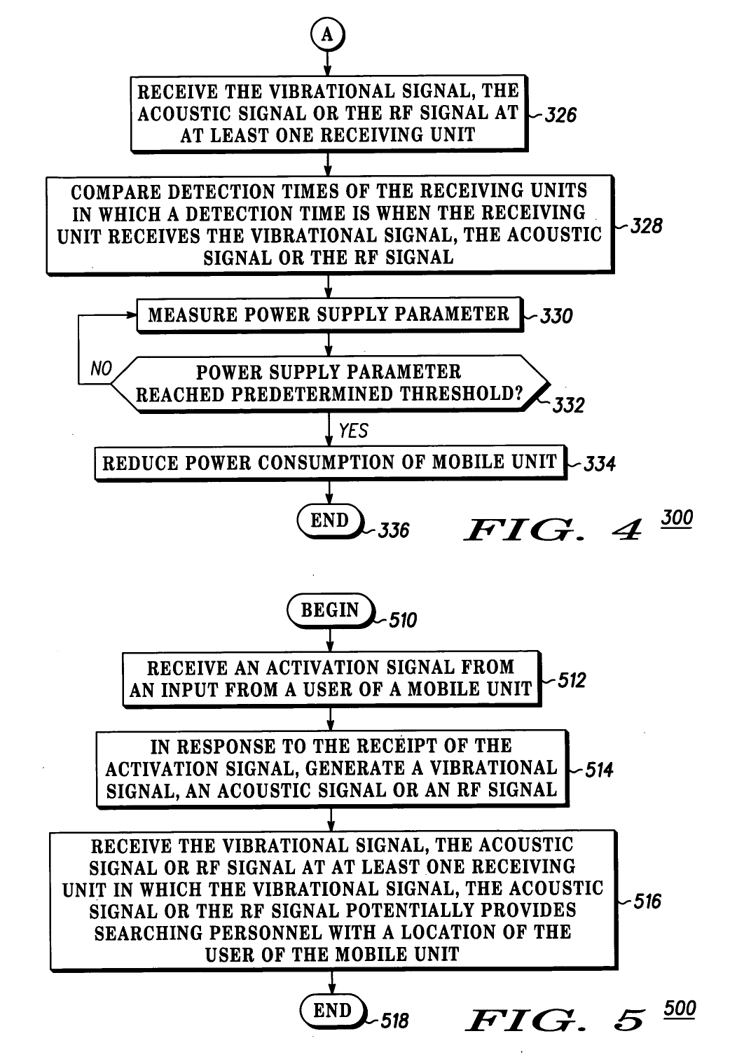

Referring to FIG. 2, the mobile unit 110, the receiver 112 and the computing device 114 are shown in block diagram form. The components shown in the mobile unit 110, the receiver 112 and the computing device 114 are merely exemplary in nature, as these devices can include a higher or fewer number of elements in comparison to what is illustrated. In one arrangement, the mobile unit 110 can include a power supply 121, such as a rechargeable battery, a processor 122, a detection component 124 coupled to the processor 122 and a signal generation component 126 also coupled to the processor 122. The mobile unit 110 can also have a user interface section 128 and a memory 130, both of which can be coupled to the processor 122. The detection component 124, the signal generation component 126 and the user interface section 128 may share one or more elements, as will be explained below.

In one arrangement, the detection component 124 can detect at the mobile unit 110 the existence of at least one marker that can be associated with a potential emergency. A marker can be any indication of a potential emergency that can be detected by an electronic device. For example, a marker can be the mobile unit 110 being dropped or a crashing sound. Specifically, the detection component 124 can include an accelerometer 132 and a microphone 134. As is known in the art, the accelerometer 132 can detect movement of the mobile unit 110. In accordance with an embodiment of the inventive arrangements, the accelerometer 132 can detect when the mobile unit 110 has been dropped or has otherwise fallen and can signal the processor 122.

Additionally, the microphone 134 can capture certain audible sounds that may provide an indication that an emergency event is occurring. For example, the microphone 134 can receive a crashing sound and can signal the processor 122. These two examples of a marker—the dropping of the mobile unit 110 and the receipt of a crashing sound—may be indications of an emergency, such as the collapse of a building.

In one arrangement, the memory 130 can be loaded with digital signatures relating to movement of the mobile unit 110 and certain sounds. For example, the digital signature relating to the movement of the mobile unit 110 can be the values typically received from the accelerometer 132 when the mobile unit 110 is dropped from a height of roughly three feet. This drop may indicate that the user of the mobile unit 110 has been knocked to the floor of a building and may become trapped. As another example, the digital signature relating to the sounds can be a signature of audio that is produced from a crashing sound, such as that of a building collapse.

These digital signatures can be referred to as predetermined thresholds, and the processor 122 can compare measurements received from the accelerometer 132 and sounds received from the microphone 134 with these predetermined thresholds. Those of skill in the art will appreciate that other values or sounds can be used for the predetermined thresholds relating to the movement of the mobile unit 110 and any captured sounds. Moreover, the detection component 124 can include other suitable elements for detecting any other suitable marker that may indicate the existence of a possible emergency.

The signal generation component 126 can generate an emergency signal to potentially provide searching personnel with a location of a user of the mobile unit 110. In one arrangement, the signal generation component 126 can include a transmitter 136, a receiver 138, both of which can be coupled to the processor 122, a transmitter/receiver (TX/RX) switch 140 and an antenna 142. The TX/RX switch 140 can be coupled to the processor 122, the transmitter 136, the receiver 138 and the antenna 142. The signal generation component 126 can further include a motor controller 144, a vibrator 146 coupled to the motor controller 144, an audio driver 148 and an audio transducer 150 coupled to the audio driver 152. The audio driver 152 and the motor controller 144 can also be coupled to the processor 122.

Through the transmitter 136, the receiver 138, the TX/RX switch 140 and the antenna 142, the mobile unit 110 can transmit and receive RF signals—such as voice and/or data signals—in a manner well known to those of skill in the art. For example, when receiving signals, the processor 122 can control the TX/RX switch 140, which can permit signals being received by the antenna 142 to pass to the receiver 138. As is known in the art, the receiver 138 can convert and demodulate these signals for further processing. When the mobile unit 110 is transmitting signals, the processor 122 can set the TX/RX switch 140 to permit the transmitter 136 to transmit communications signals though the antenna 142. As is also known in the art, the transmitter 136, through instructions received from the processor 122, can encode information onto any signal transmitted from the mobile unit 110. This encoded information can include both voice and data elements.

The motor controller 144 can receive signals from the processor 122 and in response, can control the operation of the vibrator 146. The vibrator 146 can produce vibrations (a vibrational signal) based on the input from the motor controller 144, which can be propagated through any suitable material. As an example, the motor controller 144 can cause the vibrator 146 to change the frequency, amplitude or duty cycle of the vibrational signal, as will be described below. In one particular arrangement, the motor controller 144 can signal the vibrator 146 to encode the vibrational signal, such as by varying the duty cycle or any other suitable parameter of the vibrational signal, that the vibrator 146 is outputting.

The audio driver 148 can also receive signals from the processor 122 and can control the operation of the audio transducer 150. As is known in the art, the audio transducer 150 can broadcast a wide variety of sounds (an acoustic signal), whether audible or inaudible to a human, which can be propagated through any suitable medium. The audio driver 148 can cause the audio transducer 150 to change the frequency, amplitude or duty cycle of the acoustic signal. Similar to the vibrational signal, the audio driver 148 can signal the audio transducer 150 to encode the acoustic signal by varying the duty cycle or any other parameter of the acoustic signal.

The user interface section 128 can permit a user of the mobile unit 110 to provide input to and receive output from the mobile unit 110. For example, the user interface section 128 can include a keypad interface 152, a keypad 154 coupled to the keypad interface 152, a display driver 156 and a display 158 coupled to the display driver 156. The keypad interface 152 and the display driver 156 can both be coupled to the processor 122. As can be seen, the user interface section 128 can share the microphone 134 with the detection component 124. The user interface section 128 can also share with the signal generation component 126 the audio driver 148, the audio transducer 150, the motor controller 144 and the vibrator 146.

A user can enter information into the mobile unit 110 through the keypad 154 or through the display 158, if the display 158 has touch-screen capabilities. The user may also enter information, such as speech commands, into the mobile unit 110 through the microphone 134, if the mobile unit 110 contains suitable voice-recognition circuitry and software.

The receiver 112 can include a detection mechanism 160, a processor 162 and an interface 164, which can be coupled to the processor 162. In one arrangement, the detection mechanism 160 can include a receiver 166, an antenna 168 coupled to the receiver 166, a geophone 170 and a microphone 172. Each of the receiver 166, the geophone 170 and the microphone 172 can have inputs into the processor 162. As is known in the art, a geophone can be used to detect vibrational signals. As an example, the geophone 170 can be an analog or digital geophone.

In accordance with an embodiment of the inventive arrangements, the detection mechanism 160 can detect an emergency signal generated by the signal generation component 126 of the mobile unit 110. For example, the receiver 166 and the antenna 168 can receive any RF signals transmitted from the transmitter 136 and the antenna 142 of the signal generation component 126. Moreover, the geophone 170 can detect vibrations received from the vibrator 146, and the microphone 172 can capture acoustic signals broadcast from the audio transducer 150. As has been alluded to earlier, the RF signals, the vibrational signals and the acoustic signals can be detected and received by the detection mechanism 160 of the receiver 112 through any suitable medium, such as building materials and natural substances, including dirt and rock.

In one arrangement, one or more of the receivers 112 can be connected by a hard-wired connection 174. The interface 164 can be configured to facilitate the communication of data between the receivers 112 over the hard-wired connections 174. As another example, the receivers 112 can be connected by a wireless connection 176, which can be used to wirelessly facilitate the transfer of data between the receivers 112 and the computing device 114. In this instance, the interface 164 can be configured to transmit and receive wireless signals, such as Bluetooth or Wi-Fi signals.

One or more of the receivers 112 can be connected to the computing device 114 through the hard-wired connection 174 or the wireless connection 176. Additionally, the computing device 114 can include an interface 178 for receiving data from the receivers 112 over the hard-wired connection 174 or the wireless connection 176. The computing device 114 can also have a processor 180 and a user interface 182 in which the processor 180 is coupled to both the interface 178 and the user interface 182. The processor 180, through the interface 178, can receive the data that is collected by the receivers 112 and can process this data accordingly. For example, as will be explained later, the processor 180 can analyze the collected data to determine the location of the mobile unit 110 and any can collect information relating to any emergency signal generated by the mobile unit 110. Any result from this process can be provided to a user through the user interface 182. As an example, the collected data can be provided to the user through a display (not shown) and/or a speaker (also not shown).

Referring to FIG. 3, a method 300 for generating an emergency signal is shown. To describe the method 300, reference will be made to FIGS. 1 and 2, although the method 300 can be practiced in other situations using any other suitable devices or systems. Moreover, the method 300 is not limited to the particular steps that are shown in FIG. 3 (or FIG. 4) or to the order in which they are depicted. The inventive method 300 may also include a higher or fewer number of steps as compared to what is shown in FIG. 3 (and FIG. 4).

At step 310, the method 300 can begin. At step 312, the existence of at least one marker associated with a potential emergency can be detected at a mobile unit. At decision block 314, it can be determined whether the detected marker has reached a predetermined threshold. If it has not, the method 300 can resume at step 312. If it has, the method 300 can continue to step 316.

For example, referring to FIGS. 1 and 2, a person 118 having a mobile unit 110 may be inside a building 116 that has collapsed. For purposes of the invention, the term user and person are synonymous. During the collapse, the mobile unit 110 may detect a marker associated with this emergency. For example, the person 118 may drop the mobile unit 110, and the accelerometer 132 can signal the processor 122. Similarly, the microphone 134 can detect a crashing sound and can transfer this detection to the processor 122. The processor 122 can compare these measured values with predetermined thresholds stored in the memory 130 to determine if one or more of the measured values, i.e., the markers, has reached a predetermined threshold. Of course, the invention is not limited to these particular markers, as other suitable indicators can be employed to detect a potential emergency situation.

Referring back to the method 300 of FIG. 3, at step 316, a wait of a predetermined amount of time can be endured before initiating the emergency signal, which can permit a user to prevent the emergency signal from being initiated. Subsequently, the emergency signal can be initiated, which may provide searching personnel with a location of a user of the mobile unit, as shown at step 318. At step 320, the emergency signal can be a vibrational signal, an acoustic signal or an RF signal. Further, the vibrational signal can be generated with a vibrational component of the mobile unit, and the acoustic signal can be broadcast with a transducer of the mobile unit. Also, the RF signal can be generated with a transmitter of the mobile unit.

Referring back to FIGS. 1 and 2, for example, once the processor 122 determines that the marker has reached the predetermined threshold, the processor 122 can signal one or more of the components in the user interface section 128 to inform the user of this occurrence. The processor 122 can enter a holding stage before it takes further action. This holding stage can be a predetermined waiting time. This waiting time can permit a user of the mobile unit 110 to prevent any emergency signal from being initiated. For example, if the mobile unit 122 mistakes a normal occurrence for an emergency situation, the user of the mobile unit 110, by providing input through the user interface section 128, can prevent the processor 122 from causing the emergency signal from being mistakenly initiated. As an example, the user may merely accidentally drop his mobile unit 110.

After the predetermined amount of wait time has expired, the mobile unit 110 can initiate an emergency signal, which may help rescue personnel locate a user of the mobile unit 110. For example, if a building 116 has collapsed, a person 118 (the user of the mobile unit 110) may have become trapped under a pile of rubble 120. To help searching personnel locate the trapped person 118, the mobile unit 110 can generate an emergency signal.

In one arrangement, the emergency signal can be a vibrational signal, and the processor 122 can signal the motor controller 144, which can cause the vibrator 146 to produce the vibrational signal. In another arrangement, the emergency signal can be an acoustic signal, and the processor 122 can signal the audio driver 148 to cause the audio transducer 150 to broadcast the acoustic signal. In yet another arrangement, the emergency signal can be an RF signal, and the processor 122 can signal the transmitter 136, which can produce the RF signal. Either of these signals can propagate through the pile of rubble 120. As will be explained below, when received, each of these signals can be used to help possibly locate the person 118.

Referring back to the method 300 of FIG. 3, at step 322, the vibrational signal can be encoded with a predetermined sequence to at least enable a receiver to detect the vibrational signal in the presence of other vibrational, non-emergency signals. In addition, the acoustic signal can be encoded with a predetermined sequence, or the RF signal can be encoded with a predetermined emergency message.

Referring back again to FIGS. 1 and 2, to encode the vibrational signal, the processor 122 can signal the motor controller 144 appropriately. For example, the processor 122 can signal the motor controller 144 to vary the duty cycle of the signal that it feeds to the vibrator 146. In particular, the processor 122 can signal the motor controller 144 to selectively turn on and off the vibrator 146 in accordance with a predetermined sequence. As an example, the predetermined sequence can correspond to Morse code or some other predetermined coding scheme used to transmit messages. As is known in the art, Morse code involves the transmission of information in which characters are represented with a series of dots, dashes and spaces. The motor controller 144, under the instruction of the processor 122, can control the operation of the vibrator 146 in accordance with this scheme (or some other suitable scheme). As such, the vibrational signal, through the encoding scheme, can carry a message as it propagates through a medium. The message can be any suitable combination of letters, such as an emergency message that requests help for the person 118.

In another arrangement, the acoustic signal can be encoded in a similar fashion. That is, the processor 122 can signal the audio driver 148 to cause the audio transducer 150 to broadcast the audio signal in accordance with a predetermined sequence. This predetermined sequence can be based on Morse code or some other coding scheme, which can permit messages to be carried over the acoustic signal. Again, this message can be an emergency message that requests help for the person 118.

An emergency message can also be encoded on the RF signal in accordance with well-known modulation techniques. Such predefined messages can be stored in the memory 130, and the processor 122 can access these messages and instruct the transmitter 136 to encode them into the RF signal. It is understood, however, that the invention is not limited in this regard. For example, the person 118 can also create messages to be carried on the emergency signal. In particular, the person 118 can enter text into the mobile unit 110 through the keypad 154 and may also provide voiced messages through the microphone 134. These user-entered messages can be encoded on the RF signal, or the processor 122 can convert them to the coding scheme used to generate the predetermined sequence to be carried on the vibrational or acoustic signals. A voice message, for example, can be converted to the appropriate coding scheme if the mobile unit 110 contains suitable voice recognition software and circuitry. Of course, those of skill in the art will appreciate that other suitable methods can be used to encode any emergency signal with any suitable type of information.

Referring back to the method 300 of FIG. 3, at step 324, the vibrational signal, the acoustic signal and the RF signal can have a predetermined frequency. In addition, one or more receiving units can be positioned substantially at a predetermined distance from one another. This predetermined distance can be an integer or fractional wavelength of the predetermined frequency of the vibrational signal, the acoustic signal or the RF signal.

As an example, referring once again to FIGS. 1 and 2, one or more receiving units 112 can be strategically positioned to receive emergency signals generated by the mobile unit 110. In one arrangement, each receiving unit 112 can be positioned a predetermined distance D apart from one another. This distance D can be based on the wavelength of the predetermined frequency of the emergency signal, whether the signal is a vibrational, acoustic or RF signal. The distance D can be an integer of the wavelength or even a fraction (e.g., ½, ¼, etc.) of the wavelength of the predetermined frequency.

To facilitate this process, the processor 122 of the mobile unit 110 can be programmed to cause the vibrational, acoustic or RF signal to be generated at a known frequency. That is, rescue or searching personnel can be made aware of the value of these predetermined frequencies before an emergency occurs. It is understood, however, that the invention is not so limited, as the receivers 112 can be positioned in any other suitable fashion.

The predetermined frequency of the emergency signal can also be adjusted. Specifically, the predetermined frequency of the vibrational signal, the acoustic signal or the RF signal can be either increased or decreased as the emergency signal is being generated. In one particular arrangement, the predetermined frequency of the vibrational signal, the acoustic signal and the RF signal can be given a value that meets the operating range of the vibrator 146, the acoustic transducer 150 and the transmitter 136, respectively.

Referring to step 326 of FIG. 4 (through jump circle A), the vibrational, acoustic or RF signal can be received by one or more of the receiving units. In addition, detection times of the receiving units can be compared. A detection time can be when the receiving unit receives the vibrational, acoustic, RF or any other suitable signal.

For example, referring to FIGS. 1 and 2, when the appropriate component of the mobile unit 110 generates the emergency signal (e.g., the vibrator 146, the audio transducer 150 and the transmitter 136), the emergency signal can propagate through, for example, the pile of rubble 120 and can be received by one or more of the receiving units 112. Specifically, the geophone 170 can detect the vibrational signal, the antenna 168 can capture the RF signal and the microphone 172 can detect the acoustic signal.

When it receives the vibrational signal, the geophone 170 can signal the processor 162 of the receiving unit 112 with the data that it collects. Also, when the microphone 172 receives the acoustic signal, the microphone 172 can signal the processor 162 with the received acoustic signal. The receiver 166, in accordance with well-known principles, can process the received RF signal and can transfer the RF signal to the processor 162.

When it receives these signals, the processor 162 of the receiving unit 112 can determine whether the received signal is an actual emergency signal. For example, the processor 162 can decode the vibrational signal received by the geophone 170 to determine that it is an actual emergency signal from the mobile unit 110, as opposed to some other vibrational signal generated by, for example, rescue equipment at the scene. The processor 162 can determine that the acoustic and RF signals are also genuine in a similar manner.

The processor 162 can signal the interface 164 to transmit the collected data to the computing device 114 over the hard-wired connection 174 or the wireless connection 176. In addition, the processor 162 can note the detection time of the received signal (vibrational, acoustic or RF), which can also be transmitted to the computing device 114.

The interface 178 of the computing device 114 can receive the transmitted signals from the receiving units 112 and can signal the processor 180. The processor 180 can gather the data transmitted from the receiving units 112, such as any message being carried on the vibrational, acoustic or RF signals, and can signal the user interface 182 to relay this information to a user. As an example, any emergency message being transmitted by the mobile unit 110 can be displayed on a display (not shown) or broadcast on a speaker (also not shown) of the user interface 182.

The processor 180 can also compare the detection times of the receiving units 112. The processor 180 can then determine the location of the mobile unit 110. This location can be provided to rescue personnel through the user interface 182. As an example, the processor 180 can determine the latitudinal, longitudinal and altitude coordinates of the mobile unit 110 based on the comparison of detection times. Other suitable positional information may also be provided.

The processor 180 can be programmed with any well-known algorithm for determining location based on the measurement of when signals are received from the mobile unit 110. Armed with this information, searching personnel can better direct their rescue efforts, particularly if the person 118 is near his or her mobile unit 110.

Referring back to the method 300 of FIG. 4, at step 330, a power supply parameter can be measured. At decision block 332, it can be determined whether the power supply parameter has reached a predetermined threshold. If it has not, the method 300 can resume at step 330. If it has, the method 300 can continue at step 334, where the power consumption of the mobile unit can be reduced. The method 300 can end at step 336.

Referring to FIG. 2, the processor 122 of the mobile unit 110 can monitor any suitable parameter of the power supply 121. As an example, the power supply 121 can be a rechargeable battery, and the parameter of the rechargeable battery that the processor 122 can monitor can be the voltage level of the rechargeable battery. Once the voltage level of the rechargeable battery reaches a predetermined threshold, the processor 122 can take steps to reduce the power consumption of the mobile unit 110. For example, the processor 122 can signal the display driver 156 to disable a backlight (not shown) of the display 158. As another example, the processor 122 can instruct the motor controller 144, the audio driver 148 or the transmitter 136 to lower the amplitude of the vibrational signal, the acoustic signal or the RF signal, respectively. In addition, the processor 122 can signal the motor controller 144, the audio driver 148 or the transmitter 136 to shorten the length of any messages carried over the vibrational signal, the acoustic signal or the RF signal, also respectively. Those of skill in the art will appreciate that many other steps can be taken to reduce the power consumption of the mobile unit 110.

Referring to FIG. 5, an alternative method 500 for generating an emergency signal is shown. This method 500 is similar to the method 300 described in relation to FIGS. 3 and 4. Here, however, the emergency signal can be initiated by a user of a mobile unit. Specifically, at step 510, the method 500 can begin, and at step 512, an activation signal can be received from an input of a user of a mobile unit. For example, referring to FIGS. 1 and 2, if the user senses or experiences an emergency situation, such as where they may become or are trapped, the user can activate a signal from the mobile unit 110. The signal can be activated through any suitable component of the user interface 128. Such a feature can supplement the automated detection of an emergency situation or can be used in lieu of the automated detection.

Referring back to FIG. 5, at step 514, in response to the receipt of the activation signal, a vibrational signal, an acoustic signal or an RF signal can be generated. Moreover, as shown at step 516, the vibrational signal, the acoustic signal or the RF signal can be received at at least one receiving unit. These signals can potentially provide searching personnel with a location of the user of the mobile unit. Steps 514 and 516 can be performed in accordance with the discussion relating to the method 300. The method 500 can then end at step 518.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for generating an emergency signal, comprising the steps of:
detecting at a mobile unit the existence of at least one marker associated with a potential emergency;
determining whether the marker has reached a predetermined threshold; and
if the marker has reached the predetermined threshold, initiating an emergency signal to potentially provide searching personnel with a location of a user of the mobile unit.

2. The method according to claim 1, wherein the marker is at least one of a movement of the mobile unit and a crash sound.

3. The method according to claim 1, wherein the emergency signal is a vibrational signal and the method further comprises the steps of:
generating the vibrational signal with a vibrational component of the mobile unit; and
receiving the vibrational signal at at least one receiving unit.

4. The method according to claim 3, further comprising the step of encoding the vibrational signal with a predetermined sequence to at least enable the receiver to detect the vibrational signal in the presence of other vibrational, non-emergency signals.

5. The method according to claim 3, wherein the vibrational signal has a predetermined frequency, and the method further comprises the step of positioning the receiving units substantially at a predetermined distance from one another, wherein the predetermined distance is at least one of an integer and a fractional wavelength of the predetermined frequency of the vibrational signal.

6. The method according to claim 3, further comprising the step of comparing detection times of the receiving units, wherein a detection time is when the receiving unit receives the vibrational signal.

7. The method according to claim 1, wherein the emergency signal is an acoustic signal and the method further comprises the steps of:
broadcasting the acoustic signal with a transducer of the mobile unit; and
receiving the acoustic signal at at least one receiving unit.

8. The method according to claim 7, further comprising the step of encoding the acoustic signal with a predetermined sequence.

9. The method according to claim 7, wherein the acoustic signal has a predetermined frequency, and the method further comprises the step of positioning the receiving units substantially at a predetermined distance from one another, wherein the predetermined distance is at least one of an integer and a fractional wavelength of the predetermined frequency of the acoustic signal.

10. The method according to claim 7, further comprising the step of comparing detection times of the receiving units, wherein a detection time is when the receiving unit receives the acoustic signal.

11. The method according to claim 1, wherein the emergency signal is a radio frequency signal, and the method further comprises the steps of:
generating the radio frequency signal with a transmitter of the mobile unit; and
receiving the radio frequency signal at at least one receiving unit.

12. The method according to claim 11, further comprising the step of encoding the radio frequency signal with a predetermined emergency message.

13. The method according to claim 11, wherein the radio frequency signal has a predetermined frequency, and the method further comprises the step of positioning the receiving units substantially at a predetermined distance from one another, wherein the predetermined distance is at least one of an integer and a fractional wavelength of the predetermined frequency of the radio frequency signal.

14. The method according to claim 11, further comprising the step of comparing detection times of the receiving units, wherein a detection time is when the receiving unit receives the radio frequency signal.

15. The method according to claim 1, when the marker has reached the predetermined threshold, further comprising the step of waiting a predetermined amount of time before initiating the emergency signal to permit the user to prevent the emergency signal from being initiated.

16. A method for generating an emergency signal, comprising the steps of:
receiving an activation signal from an input from a user of a mobile unit;
in response to the receipt of the activation signal, generating at least one of a vibrational signal and an acoustic signal; and
receiving at least one of the vibrational signal and the acoustic signal at at least one receiving unit, wherein at least one of the vibrational signal and the acoustic signal potentially provides searching personnel with a location of the user of the mobile unit.

17. The method according to claim 16, wherein the generating step further comprises generating at least one of the vibrational signal, the acoustic signal and a radio frequency signal, wherein the receiving step further comprises receiving the radio frequency signal at the receiving unit and wherein the radio frequency signal potentially provides searching personnel with a location of the user of the mobile unit.

18. A system for generating an emergency signal, comprising:
a mobile unit, comprising:
a detection component, wherein the detection component detects at the mobile unit the existence of at least one marker associated with a potential emergency;
a processor coupled to the detection component, wherein the processor is programmed to determine whether the marker has reached a predetermined threshold; and
a signal generation component coupled to the processor, wherein the processor is programmed to signal the signal generation component when the detected marker has reached the predetermined threshold and in response, the signal generation component generates an emergency signal to potentially provide searching personnel with a location of a user of the mobile unit.

19. The system according to claim 18, wherein the marker is at least one of a movement of the mobile unit and a crash sound.

20. The system according to claim 18, further comprising at least one receiving unit and wherein the signal generation component comprises a vibrator and the emergency signal is a vibrational signal generated by the vibrator, wherein at least one of the receiving units receives the vibrational signal.

21. The system according to claim 18, further comprising at least one receiving unit, wherein the mobile unit further comprises a transducer and the emergency signal is an acoustic signal broadcast by the transducer that is received by at least one of the receiving units.

22. The system according to claim 18, further comprising at least one receiving unit and wherein the mobile unit further comprises a transmitter and the emergency signal is a radio frequency signal that the transmitter transmits and that at least one of the receiving units receives.

23. A system for generating an emergency signal, comprising:
a mobile unit, comprising:
a user interface section;
a processor coupled to the user interface section, wherein the user interface section provides the processor with an activation signal from a user of the mobile unit; and
a signal generation component coupled to the processor, wherein the processor is programmed to signal the signal generation component when the processor receives the activation signal, wherein in response, the signal generation component generates at least one of a vibrational signal and an acoustic signal and at least one of the vibrational signal and the acoustic signal provides searching personnel with a location of the user of the mobile unit.

24. The system according to claim 23, further comprising at least one receiving unit, wherein the signal generation component generates at least one of the vibrational signal, the acoustic signal and a radio frequency signal, wherein at least one of the receiving units receives at least one of the vibrational signal, the acoustic signal and the radio frequency signal, wherein the radio frequency signal potentially provides searching personnel with a location of the user of the mobile unit.
